(19) United States
(12) Patent Application Publication
(10) Pub. No.: US 2004/0125865 A1
(43) Pub. Date: Jul. 1, 2004

(54) Maximum signal-to-interference-and-noise spread spectrum rake receiver and method

(76) Inventors: Colin D. Frank, Park Ridge, IL (US); Robert J. Corke, Glen Ellyn, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/335,292

(22) Filed: Dec. 30, 2002

(51) Int. Cl. H04B 1/707

(52) U.S. Cl. 375/148

(57) ABSTRACT

A RAKE receiver (200) incorporates maximum signal-to-interference-and-noise ratio (SINR) combining, implemented adaptively using the least mean-square (LMS) adaptation, recursive least-square adaptation, or multi-stage Weiner adaptation to adjust the weightings for RAKE finger combining. Alternatively, the weighting values for RAKE finger combining may be determined by estimation of the channel mean and the signal correlation matrix from the pilot, and projection of the mean onto the inverse of the correlation matrix. The weightings for these methods result in a combined RAKE receiver output having enhanced, near maximum, SINR. A particular implementation method (400) incorporates the step of LMS adapting RAKE finger weights in order to enhance the combined RAKE receiver output.

### TECHNICAL FIELD

This patent relates to receivers for use in a spread spectrum communication system.

### BACKGROUND

In a spread spectrum communication system, downlink transmissions from a base station to a mobile station include a pilot channel and a plurality of traffic channels. The pilot channel is demodulated by all users. Each traffic channel is intended for demodulation by a single user, though more than one channel may be intended for a given user. Therefore, each traffic channel is spread using a unique code-known by both the base station and the mobile station. The pilot channel is spread using a code known by the base station and all mobile stations. Multiplication of the pilot channel and traffic channel symbols by unique code sequences comprised of chips having duration much less than the symbol duration spreads the spectrum of transmissions in the system.

One example of a spread spectrum communication system is a cellular radiotelephone system according to Telecommunications Industry Association/Electronic Industry Association (TIA/EIA) Interim Standard IS-95, “Mobile Station-Base Station Compatibility Standard for Dual-Mode Wideband Spread Spectrum Cellular System” (IS-95). Individual users in the system use the same frequency spectrum but are distinguishable from each other through the use of individual spreading codes. IS-95 is an example of a direct sequence code division multiple access (DS-CDMA) communication system. In a DS-CDMA system, transmissions are spread by a pseudorandom noise (PN) code. Data is spread by a sequence of chips, where the chip is the spread spectrum minimal-duration keying element.

Other spread spectrum systems include radiotelephone and data systems operating at various frequencies and utilizing various spreading techniques. Among these additional systems are third-generation spread spectrum communication systems (3G) and wideband code division multiple access systems (W-CDMA).

Mobile stations for use in spread spectrum communications systems have employed RAKE receivers. A RAKE receiver is a form of a matched filter receiver that includes one or more receiver fingers independently demodulating radio frequency (RF) signals. Each finger both estimates the channel gain and phase using the known pilot channel and demodulates the traffic channel component of the RF signal to produce traffic symbol estimates. The traffic symbol estimates from the receiver fingers are multiplied by the complex conjugate of the channel estimates of the corresponding fingers and summed to produce a combined symbol estimate. A RAKE receiver combines multipath rays and thereby exploits channel diversity. Generally, the RAKE receiver fingers are assigned to the strongest set of multipath rays.

A RAKE receiver requires a combiner to phase correct and sum the symbol estimates produced by the fingers. The optimal combiner produces a combined estimate, s(t), which has maximum signal-to-interference-and-noise (STIR) over the set of all linear combiners. Current combiner implementations are not optimal in this sense.

Thus, there is a need for a spread spectrum RAKE receiver with optimal linear combining that provides maximum SINR.

### BRIEF DESCRIPTION OF THE DRAWINGS

This disclosure will describe several embodiments to illustrate its broad teachings. Reference is also made to the attached drawings.

FIG. 1 is a block diagram of a communication system.

FIG. 2 is a block diagram of a receiver.

FIG. 3 is a block diagram of an LMS adaptation loop for a RAKE finger according to an embodiment.

FIG. 4 is a flow diagram illustrating a method of LMS adapting RAKE receiver output.

### DETAILED DESCRIPTION

A maximum SINR receiver can be implemented either adaptively, using least mean-squares (LMS), recursive least-squares (RLS), or multi-stage Weiner adaptation, or directly by estimation of the channel mean as well as the signal correlation matrix for the set of RAKE fingers, and projection of the mean onto the inverse of the correlation matrix.

In an embodiment, the RAKE receiver incorporates an adaptive algorithm, such as the least mean-squares (LMS), the recursive least-squares (RLS), or multi-stage Wiener, to adaptively adjust the RAKE finger weightings. The resulting adaptive weighting results in combined RAKE receiver output having an enhanced, near maximum, signal-to-interference-and-noise ratio (SINR). A method of receiving a spread spectrum signal incorporates the step of LMS, RLS, or multi-stage Weiner adaptation of the RAKE finger weights in order to enhance the combined RAKE receiver output. An alternative method of receiving a spread spectrum signal incorporates the step estimation of the channel mean and the signal correlation matrix for the set of RAKE fingers from the pilot signal, and computation of the near maximum SINR combining coefficients by projection of the mean onto the inverse of the correlation matrix.

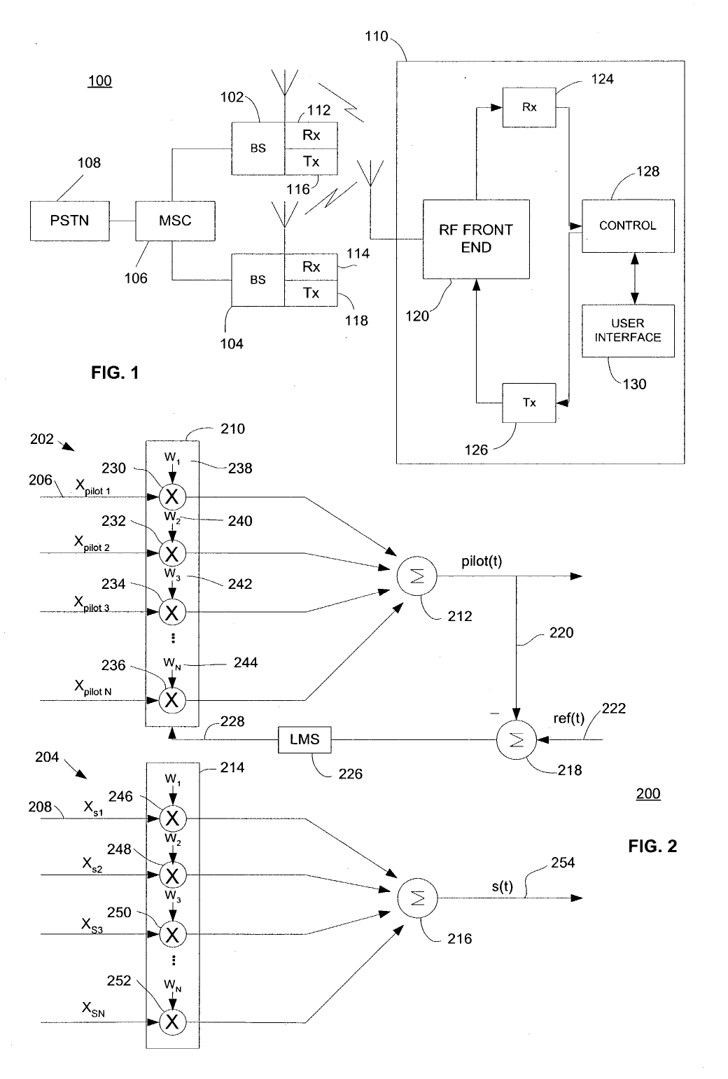

Referring to FIG. 1, a communication system 100 includes a plurality of base stations including base station 102 and base station 104. Each base station is separately coupled to a mobile switching center 106, which controls communication within the system and between the system and the public switch telephone network 108. The communication system 100 may be a cellular telephone system operating according to IS-95, 3G, W-CDMA or other direct sequence spread spectrum communication standards, another type of cellular or mobile communication system, a fixed wireless loop system or other type of radio system.

Each base station is configured for radio frequency (RF) communication with fixed or mobile transceivers such as mobile station 110. Accordingly, each base station includes a receiver such as receiver 112 of the base station 102 and receiver 114 of the base station 104 and a transmitter such as transmitter 116 of the base station 102 and the transmitter 118 of the base station 104. Each transmitter transmits a spread spectrum signal including a first signal and a second signal, the first signal being substantially orthogonal to the second signal. The first signal may be, for example, the pilot channel in the IS-95 implementation and the second signal may be one or more traffic channels. In IS-95, the pilot channel and the traffic channels are covered using a Walsh or Hadamard code, so that at transmission, the channels are all substantially orthogonal.

The mobile station 110 includes an RF front end 120, a receiver 124, a transmitter 126, a control section 128 and a user interface 130. The RF front end 120 filters the spread spectrum signals and provides conversion to baseband signals. The RF front end 120 further provides analog to digital conversion, converting the baseband signals to streams of digital data for further processing. The receiver 124 demodulates the digital data and provides the demodulated data to the control section 128. The receiver 124 is a RAKE receiver adapted or combined as described herein.

The control section 128 controls overall operation of the mobile station 110, including assignment of the RAKE fingers. The control section also controls interaction of the radio components and the user interface 130. The user interface 130 typically includes a display, a keypad, a speaker and a microphone. The transmitter 126 modulates data for transmission to a remote receiver, such as one of the base stations. The modulated data are processed by the front end 120 and transmitted at radio frequency.

Referring to FIG. 2, a RAKE receiver structure 200 that may be included in the receiver 124, and which includes a pilot stage 202 and a traffic channel stage 204. Within the stage 202 there is a plurality of pilot fingers, generally illustrated as pilot finger 206, output from a pilot demodulation portion (not depicted) of the RAKE receiver 200. Similarly, within the stage 204 there is a plurality of traffic channel fingers, generally illustrated as traffic channel finger 208, output from a traffic channel demodulation portion (not depicted) of the RAKE receiver 200. Each of the pilot fingers 206 within the stage 202 are input to a finger weighting device 210 before being summed in an adder 212. Similarly, each of the traffic channel fingers 208 within the stage 204 are input to a finger weighting device 214 before being summed in an adder 216. The RAKE receiver 200 further includes a summer 218 that sums a sample 220 the output of the combiner 212, i.e., the pilot signal, with a reference signal 222 that is known a priori (typically equal to 1 or some other positive constant for IS-95 and CDMA2000), to provide an input signal 224 to a least mean-square (LMS), recursive least-square, or multi-stage Weiner adaptation device 226. In the embodiment in FIG. 2, the LMS adaptation device 226 provides a weighting adaptation signal 228 to the weighting device 210, which influence the weighting values 238-244.

It is worth noting at this point that the RAKE receiver 200 is represented in block diagram form, and it may be implemented in various different ways. For example, the RAKE receiver 200 may be implemented in hardware components, application specific integrated circuits, programmed digital signal processors (DSPs), programmed specific or general purpose processors or combinations of these technologies well know to one having ordinary skill in the art.

The weighting device 210 includes a number of multipliers, 230-236 corresponding to the number of pilot fingers 206. Each multiplier 230-236 has as inputs a respective one of the pilot fingers 206 and a weighting value 238-244. The respective weighting values 238-244 are determined by the weighting device 210 in response to the weighting adaptation signal 228 provided by the LMS adaptation device 226. Alternatively, the weighting values 238-244 may be determined elsewhere in the RAKE receiver 200, such as in a controller portion thereof, and provided to the weighting adaptation device 210. Thus, each pilot finger 206 is weighted, i.e., multiplied, by its corresponding weighting value and the weighted pilot fingers are input to the summer 212 to provide the pilot signal 220. Alternatively, a single multiplier may be used and reused repeatedly to weight each of the pilot fingers. Alternatively, the weighting values 238-244 may be determined by other appropriate adaptive algorithms, such as the recursive least-squares algorithm or the multi-stage Weiner algorithm, or even by estimation of the channel mean and signal correlation matrix from the pilot, and projection of the mean onto the inverse of the correlation matrix.

The weighting device 214 similarly includes a plurality of multipliers 246-252 that each of which has as inputs a corresponding one of the traffic channel fingers 208 and weighting values 238-244. The weighting values 238-244 may be provided to the weighting device 214 from the source of determination, such as the weighting device 210, or may be determined by the weighting device 214. The weighting device 214 weights, that is, multiplies, each traffic channel finger 208 by a corresponding weighting value. The weighted traffic channel fingers are then input to the summer 216 to provide a traffic channel signal 254. The same weights may be applied to the traffic channel fingers 208 as the pilot channel fingers 206. The combined traffic channel SINR is a scalar multiple of the combined pilot SINR. Therefore, since the optimal weights maximize the combined pilot SINR, the combined traffic channel SINR is maximized as well.

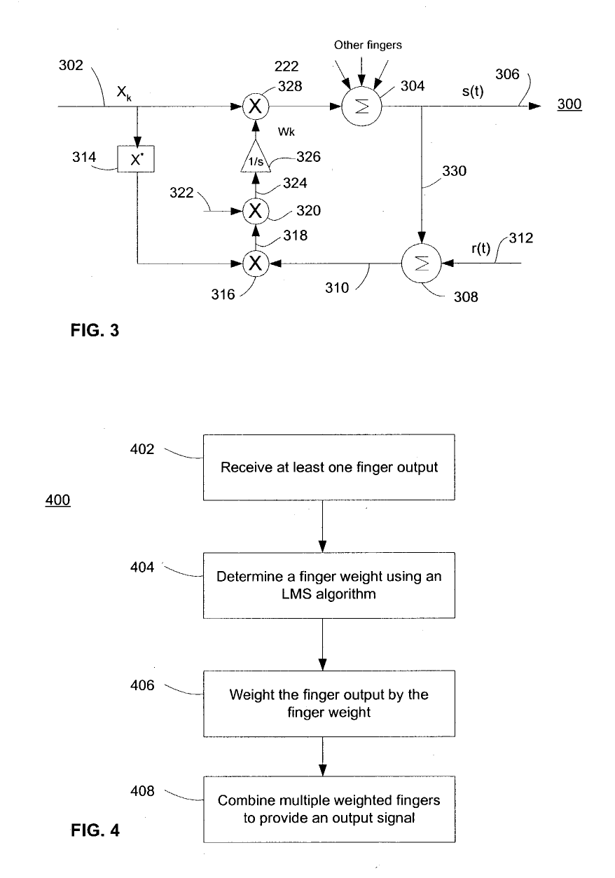

FIG. 3 illustrates an LMS loop, i.e., a structure 300 for determining a weighting value for a single finger of the RAKE receiver 200. Of course, as noted above, the structure 300 may be implemented in hardware, software or combinations of these technologies. For reference, FIG. 3 illustrates one finger 302, xₖ, which may be either a pilot finger or a traffic channel finger and a summer 304 for combining each of the fingers to generate an output signal 306, s(t). The structure 300 includes an adder 308 for generating a difference signal 310 between a sample 330 of the output signal 306 and a reference signal 312, r(t). The reference signal 312, the pilot, is known a priori. A first multiplier 316 multiplies the difference signal 310 and a complex conjugate sample 314, x*, of the finger to provide a first product signal 318. A second multiplier 326 multiplies the first product signal 318 by a factor 322, β, to provide a second product signal 324, which is accumulated by the integrator 326 to generate the weighting factor, wₖ, for the corresponding finger, xₖ. The finger, xₖ, is then weighted, i.e., multiplied, by the weighting factor, wₖ, by multiplier 328 to provide a weighted finger for input to the summer 304. One loop/structure 300 may be shared to generate each of the required weighting factors or multiple structures 300 may be provided within the RAKE receiver.

Referring to FIG. 4, a method of LMS adaptation of the RAKE finger weighting begins with receiving 402 at least one finger output from a RAKE receiver demodulator. A finger weight is determined based upon an LMS algorithm 404, and the at least one finger output is weighted 406 based upon the determined finger weight. Finally, although not necessarily part of the method, the finger is combined 408 with other weighted fingers to provide an output symbol estimate.

This patent describes several specific embodiments including hardware and software embodiments of LMS adaptation of RAKE finger weights. The invention recognizes that when the bandwidth of the channel fading process is significantly less than the symbol rate of the transmitted data and the power spread of the channel multipath despread by the the Rake fingers is within a specified range the LMS criterion may be used to adaptively adjust the weights applied to each finger output of the RAKE receiver in order to achieve maximum SINR in the combined output symbol estimate. However, one of ordinary skill in the art will appreciate that various modifications and changes can be made to these embodiments, including but not limited to the use of either the RLS algorithm or the multi-stage Weiner algorithm to determine the weights. Alternatively, the weighting values may be determined by estimation of the channel mean and the signal correlation matrix from the pilot, and projection of the mean onto the inverse of the correlation matrix. Accordingly, the specification and drawings are to be regarded in an illustrative rather than restrictive sense, and all such modifications are intended to be included within the scope of the present patent.

We claim:

1. An apparatus comprising:
a weighting device, the weighting device being coupled to receive at least one finger output of a RAKE receiver demodulator; and
a finger weight coupled to the weighting device, the finger weight being determined in accordance with a weighting algorithm taking as an input at least a known reference signal and an output pilot symbol;
wherein the weighting device weights the at least one finger based upon the finger weight.

2. The apparatus of claim 1, wherein the weighting algorithm comprises at least one of an a least mean-squares (LMS), an adaptive recursive least-squares (RLS), a multi-stage Weiner algorithm, or a estimation of a channel mean and a signal correlation matrix from the pilot symbol and a projection of the mean onto an inverse of a correlation matrix.

3. The apparatus of claim 1, wherein the weighting device comprises a multiplier and wherein the multiplier multiplies the finger output and the finger weight.

4. The apparatus of claim 1, wherein the finger weight comprises a gain adjustment of the finger output.

5. The apparatus of claim 1, wherein the finger weight comprises a phase adjustment of the finger output.

6. The apparatus of claim 1, wherein the finger output comprises either a pilot channel finger or a traffic channel finger.

7. In a RAKE receiver having a plurality of finger demodulators each providing a respective RAKE finger output the RAKE receiver thus having a plurality of RAKE finger outputs, the RAKE receiver comprising:
a weighting device, the weighting device being coupled to receive the plurality of RAKE finger outputs; and
a plurality of finger weights coupled to the weighting device, one each of the plurality of finger weights corresponding to a respective one of the finger outputs the finger weights being determined in accordance with a weighting algorithm taking as an input at least a known reference signal and a RAKE receiver pilot symbol output;
wherein the weighting device weights each of the plurality of RAKE finger outputs based upon the respective finger weight of the plurality of finger weights.

8. The apparatus of claim 7, wherein the weighting algorithm comprises at least one of a least mean-squares (LMS), an adaptive recursive least-squares (RLS), a multi-stage Weiner algorithm, or a estimation of a channel mean and a signal correlation matrix from the pilot symbol and a projection of the mean onto an inverse of a correlation matrix.

9. The RAKE receiver of claim 7, wherein the RAKE finger outputs comprise a plurality of pilot finger outputs and a plurality of traffic channel finger outputs, wherein one each of the plurality of finger weights corresponds to a respective pilot finger output and a respective traffic finger output.

10. The RAKE receiver of claim 7, comprising a summer coupled to the weighting device to combine the weighted RAKE finger outputs to provide a combined RAKE receiver output.

11. The apparatus of claim 7, wherein the weighting device comprises a multiplier, wherein the multiplier multiplies a RAKE finger output of the plurality of RAKE finger outputs by the corresponding finger weight.

12. The apparatus of claim 7, wherein the weighting device comprises a plurality of multipliers, wherein each of the plurality of multipliers multiplies a RAKE finger output of the plurality of RAKE finger outputs by the corresponding finger weight.

13. The apparatus of claim 7, wherein each finger weight comprises a gain adjustment of the corresponding finger output.

14. The apparatus of claim 7, wherein each finger weight comprises a phase adjustment of the corresponding finger output.

15. In a RAKE receiver having a plurality of RAKE finger outputs, a method of adapting RAKE finger weighting corresponding to the RAKE finger outputs, the method comprising:
receiving at least one of the RAKE finger outputs;
determining a finger weight based upon a weighting algorithm;
weighting the at least one of the RAKE finger outputs based upon the finger weight.

16. The method of claim 15, wherein step of determining a finger weight comprises determining a finger weight using a weighting algorithm comprising at least one of a least mean-squares (LMS), an adaptive recursive least-squares (RLS), a multi-stage Weiner algorithm, or a estimation of a channel mean and a signal correlation matrix from the pilot symbol and a projection of the mean onto an inverse of a correlation matrix.

17. The method of claim 15, wherein the step of weighting the at least one of the RAKE finger outputs based upon the finger weight comprises multiplying the at least one RAKE finger output and the finger weight.

18. The method of claim 15, wherein the step of determining a finger weight based upon a LMS or other appropriate algorithm such as either the adaptive RLS or multi-stage Weiner algorithms, or by estimation of the channel mean and the signal correlation matrix from the pilot, and projection of the mean onto the inverse of the correlation matrix comprises determining the finger weight based upon a known reference signal and a RAKE receiver pilot symbol output.

19. The method of claim 15, wherein the step of receiving at least one of the RAKE finger outputs comprises receiving a pilot finger and a traffic channel finger, and wherein the step of weighting the at least one of the RAKE finger outputs based upon the finger weight comprises weighting each of the pilot finger and the traffic channel finger and the finger weight.

20. A RAKE receiver having a plurality of RAKE finger outputs comprising:
means for receiving at least one of the RAKE finger outputs;
means for determining a finger weight; and
means for weighting the at least one of the RAKE finger outputs based upon the finger weight.
